(19) United States
(12) Patent Application Publication
(10) Pub. No.: US 2012/0126162 A1
(43) Pub. Date: May 24, 2012

(54) STEAM TURBINE VALVE

(75) Inventors: Hiroshi HARUYAMA, Hitachi (JP); Shinya IMANO, Hitachi (JP); Jun SATO, Hitachi (JP); Seunghwan PARK, Mito (JP)

(73) Assignee: Hitachi, Ltd.

(21) Appl. No.: 13/298,317

(22) Filed: Nov. 17, 2011

(30) Foreign Application Priority Data
Nov. 19, 2010 (JP) 2010-258462

(51) Int. Cl. F16K 25/00; B21D 51/16

(52) U.S. Cl. 251/368; 29/890.131

(57) ABSTRACT

A steam turbine valve has a valve seat, a valve rod or a valve body in which a 3 to 5 mm thick stellite sheet is welded to ferrite cast steel by friction-stir welding, and it is preferable that a stellite layer made of the stellite sheet welded by friction-stir welding is equiaxial crystal and cast structure is not included, that an inclusion of iron into the stellite layer up to 2 mm thick from the surface of the stellite layer in the direction of ferrite cast steel is 3% or less by weight, and that a dilution layer formed between the stellite layer and the ferrite cast steel is 1 to 2 mm thick.

### CLAIM OF PRIORITY

The present application claims priority from Japanese Patent application serial No. 2010-258462, filed on Nov. 19, 2010, the content of which is hereby incorporated by reference into this application.

### TECHNICAL FIELD

The present invention relates to a steam turbine valve, specifically to a steam turbine valve wherein abrasion resistance of a valve seat or a valve rod has been improved.

### BACKGROUND ART

In a steam turbine, a main steam stop valve, a main steam control valve, a reheat steam stop valve, a reheat steam control valve, and an intercept valve are installed for the purpose of intercepting or controlling inflow of steam. The 12Cr ferrite cast steel is used for the contact and sliding portions of the valve seat and the valve rod; however, the base material alone does not sufficiently satisfy abrasion resistance. Therefore, the contact portion of the valve seat is welded by build-up welding using cobalt base alloy (stellite), and nitriding treatment or the like is applied to the sliding portion of the valve rod in order to improve abrasion resistance of each portion.

Patent Literature 1 discloses a steam valve wherein contact and sliding surfaces of a 12Cr-steel steam turbine valve have been welded by build-up welding using stellite (cobalt base alloy), thereby improving abrasion resistance and oxidation resistance.

Patent Literature 2 discloses a mushroom valve production method wherein a sintered stellite sheet member is welded by diffusion welding, friction welding, forge welding, or high-temperature brazing and soldering.

### CITATION LIST

### Patent Literature

[Patent Literature 1] Published unexamined Japanese patent application No. Hei 6 (1994)-221105
[Patent Literature 2] Published unexamined Japanese patent application No. Sho 60 (1985)-166710

### SUMMARY OF INVENTION

### Technical Problem

When building up stellite by build-up welding, cracks tend to occur due to residual stress. Also, since build-up welding and friction welding use temperatures higher than the melting temperature of stellite, postweld metal structure becomes the same structural form as that of cast structure. In such a structural form, dendrite crystallizes when the molten state changes to the solidified state, and eutectic carbide or boride deposits in the pores of dendrite. As a result, deposited eutectic carbide or boride will selectively corrode, causing cracks to occur from the corroded portion during operation, which is a problem. If cracks occur, repair build-up welding, stress relief annealing, and finish turning need to be carried out again, which increases costs.

On the other hand, nitriding treatment improves abrasion resistance; however, there is a problem in that oxidation resistance decreases. When a main steam control valve is oxidized by high-temperature steam, oxidized scale that has developed over operating time decreases a gap of the sliding portion, and if the scale is not removed at each periodic inspection, the sliding portion will become firmly fixed.

As stated above, any of conventional technologies did not satisfy both the abrasion resistance of the turbine member and costs.

An object of the present invention is to provide a steam turbine valve having excellent abrasion resistance.

### Solution to Problem

A steam turbine valve according to the present invention has a valve seat, a valve rod or a valve body wherein a 3 to 5 mm thick stellite sheet is welded to ferrite cast steel by friction-stir welding.

### ADVANTAGEOUS EFFECTS OF INVENTION

According to the present invention, it is possible to provide a steam turbine valve having excellent abrasion resistance.

### BRIEF DESCRIPTION OF DRAWINGS

FIG. 1 is a cross-sectional view showing the welding condition between ferrite cast steel and stellite sheet to explain the concept of the present invention.

FIG. 2 is a perspective view showing the welding condition between ferrite cast steel and stellite sheet to explain the concept of the present invention.

FIG. 3 is a perspective view of a steam turbine valve seat according to an embodiment of the present invention.

FIG. 4 is a cross-sectional view of a steam turbine valve according to an embodiment of the present invention.

### DESCRIPTION OF EMBODIMENTS

A steam turbine valve according to the present invention has a valve seat or a valve rod wherein a 3 to 5 mm thick stellite sheet is welded to ferrite cast steel by friction-stir welding.

A friction-stir welding method is a method by which a stirring tool composed of a columnar member made of material substantially harder than the material to be welded is inserted into the welding portion of the material to be welded while rotating the tool, and the rotating stirring tool is moved, thereby welding is performed by heat generated by friction between the stirring tool and the material to be welded.

The friction-stir welding softens the material to be welded by heat generated by friction between the stirring tool and the material to be welded, and the friction-stir welding uses a plastic flow phenomenon that occurs associated with the rotation of the stirring tool, which is based on a different principle from an arc welding method by which a material to be welded is melted.

Since the present invention uses solid-phase diffusion welding at temperatures lower than the melting temperature of stellite, the postweld metal structure is equiaxial crystal and cast structure is not included. Therefore, it is possible to prevent weld cracks caused by residual stress or selective corrosion of eutectic carbide and so on as well as cracks during operation.

Furthermore, by making a dilution layer of the stellite layer and the ferrite cast steel 1 to 2 mm thick, inclusion of iron into the stellite layer can be reduced, and reduction of abrasion resistance can be suppressed. If inclusion of iron into the stellite layer up to 2 mm thick from the surface layer of stellite in the direction of ferrite cast steel is preferably 3% or less by weight, sufficient abrasion resistance is provided.

Unlike friction-stir welding in which sheet materials butt each other, the present invention also has an effect of friction-stir treatment for refining the structure of the surface layer of stellite while performing friction-stir welding. Accordingly, the surface of stellite is highly strengthened, making it possible to further improve abrasion resistance.

Hereafter, embodiments of the present invention will be described in detail with reference to the drawings.

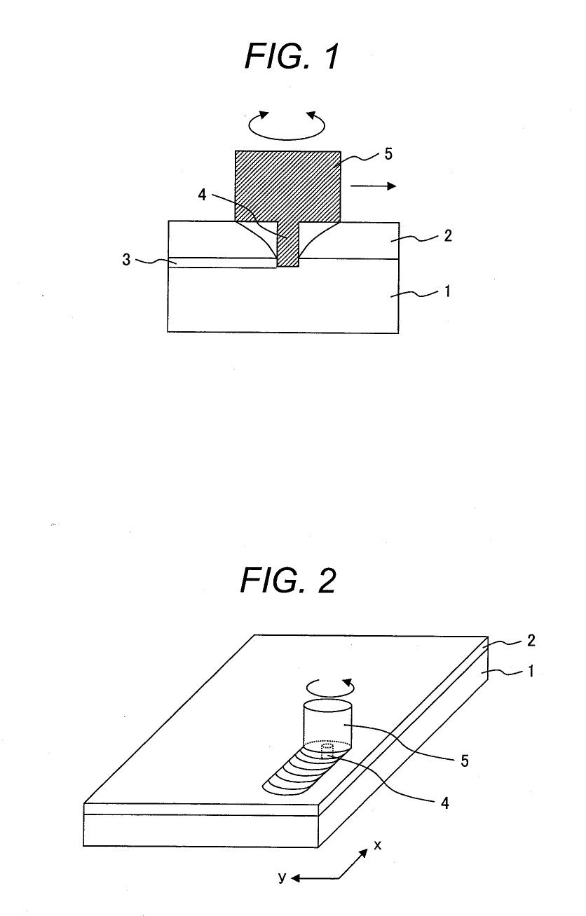

FIG. 1 is a cross-sectional view showing the welding condition between ferrite cast steel and stellite sheet to explain the concept of the present invention. FIG. 2 is a perspective view of FIG. 1.

A 3 to 5 mm thick stellite sheet 2 is fixed onto the surface of ferrite cast steel 1 (base material of a valve seat or a valve rod), and a stirring tool 5 having a pin-like probe 4 at the tip thereof is inserted while rotating the stirring tool and the rotating stirring tool is then moved, thereby softening welding material (stellite and ferrite cast steel) by heat generated by friction between the stirring tool and stellite or ferrite cast steel, and then welding is performed by the use of a plastic flow phenomenon that occurs associated with the rotation of the stirring tool.

A dilution layer 3 is formed between the ferrite cast steel 1 and the stellite sheet 2; however, since welding is performed by solid phase diffusion, the postweld structure becomes equiaxial crystal and cast structure is not included. Therefore, it is possible to prevent weld cracks caused by residual stress or selective corrosion of eutectic carbide and so on as well as cracks during operation.

As a friction-stir welding condition, a stirring tool made of cobalt base alloy that uses intermetallic compound Co₃(A1, W) having high hardness even at high temperatures is used. Alternatively, high-hardness ceramics such as PCBN (Polycrystalline Cubic Boron Nitride) may be used. It is preferable that the number of revolutions of the spindle of the stirring tool be 200 to 1200 rpm and the speed of welding be 20 to 400 mm/min.

As a welding method, it is possible to weld the whole surface by moving the stirring tool or a location of stirring in the x and y directions shown in FIG. 2; however, when the area of welding is large with regard to the diameter of the stirring tool, it is possible to partially execute friction-stir spot welding to prevent the stellite sheet being welded from bending and then weld the equally-spaced grid-like or whole surface.

Furthermore, after stir welding has been finished, there can be provided a heating process for thermally treating the welded portion or a cutting process for removing roughness on the stellite surface generated after friction-stir has been finished.

### Embodiment 1

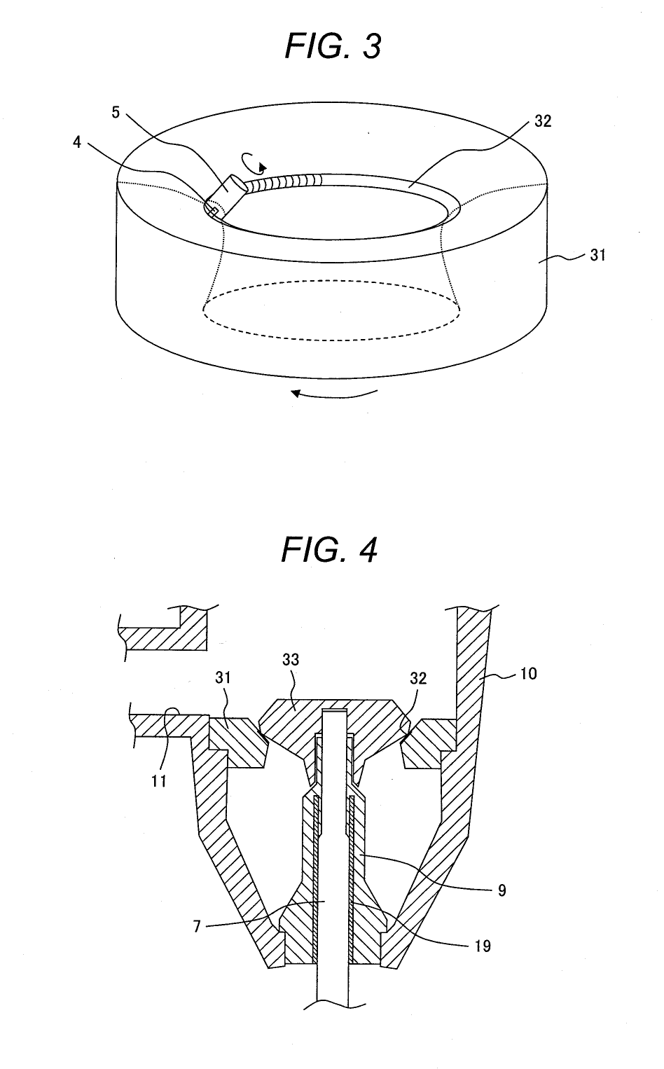

FIG. 3 is a perspective view of a steam turbine valve seat showing an embodiment in which the present invention is applied to a valve seat of the steam turbine valve. A stellite layer 32 composed of 3 mm thick stellite No. 6 was fixed onto a valve seat 31 made of 12Cr ferrite cast steel, and friction-stir welding was performed by the use of the above-mentioned stirring tool 5. In FIG. 3, welding was performed on the circumference of the valve seat by circumferentially rotating the valve seat and the stellite sheet; however, depending on the configuration of the equipment, it is possible to perform welding by fixing the valve seat and the stellite sheet and moving the stirring tool along the circumference of the valve seat while rotating the stirring tool.

Herein, material of the valve seat may be 8 to 13Cr steel as long as it is ferrite cast steel; and it is obvious that the stellite sheet is not limited to the above-mentioned material as long as it is cobalt base alloy such as stellite No. 21 and so on.

As the result of welding with the number of revolutions of spindle of 200 to 1200 rpm and the welding speed of 20 to 400 mm/min, the postweld surface after performing friction-stir welding was smooth and there was no occurrence of defects such as a pinhole and void or weld cracks.

### Embodiment 2

FIG. 4 is a cross-sectional view of a steam turbine valve according to the present invention. The steam turbine valve according to this embodiment comprises a valve seat 31, a valve body 33, a valve rod 7 for moving the valve body 33 upward with regard to the valve seat 31, a pressure seal head 9 which is a cylindrical support member for slidably supporting the valve rod 7, and a casing 10 for accommodating those parts.

In the casing 1, there is formed a valve chamber that is divided into upper and lower parts by the valve seat 31. An inflow port 11 through which steam flows in is provided in the upper part of the valve chamber partitioned by the valve seat 31. An outflow port (unillustrated) through which steam flows out is provided in the lower part of the valve chamber partitioned by the valve seat 31 in the vertical direction in the drawing.

The pressure seal head 9 is fixed onto the bottom of the valve chamber partitioned by the valve seat 31, and the pressure seal head has a hole through which the valve rod 7 passes. Furthermore, a cylindrical bush 19 through which the valve rod 7 passes is inserted into the hole of the pressure seal head 9 and fitted together. The valve body 33 is fixed onto the upper end portion of the valve rod 7. A valve rod drive unit (unillustrated) for driving the valve rod 7 up and down is provided in the lower part of the valve rod 7.

The valve seat 31, valve body 33, pressure seal head 9, and the casing 10 are made of ferrite cast steel. Furthermore, cobalt base alloy (stellite) is used for the bush 19, and incoloy (main component is nickel-chromium-iron) having high oxidation resistance and high abrasion resistance is used for the valve rod 7. Nitriding treatment has been applied to the sliding portion of the valve rod. The bush 19 and the valve rod 7 are not limited to those mentioned above and may be any material that has corrosion resistance, heat resistance, and abrasion resistance.

FIG. 4 shows the steam valve closing state. The valve rod drive unit drives the valve rod 7 to lift the valve body 33 up. As the result, the valve body 33 moves away from the valve seat 31, and steam that has flown in through the inflow port 11 flows between the valve body 33 and the valve seat 31 and then flows to the outflow port (unillustrated).

In this embodiment, a stellite layer 32 was welded by friction-stir welding to the contact portion of the valve seat 31 that comes in contact with the valve body 33. Because the contact portion between the valve seat and the valve body is a line contact on the circumference, roughness of the surface of the valve seat that had been welded in the same manner as embodiment 1 was cut in the turning process, and subsequently assembled.

In the above-mentioned embodiment, a stellite sheet is welded to the valve seat by friction-stir welding, and the same method can be applied to the valve body and the valve rod. As for the valve body, a stellite layer is welded by friction-stir welding to the contact portion of the valve body that comes in contact with the valve sheet. As for the valve rod, ferrite cast steel is used as the material of the valve rod, and a stellite layer is welded to the sliding portion by friction-stir welding. Specifically, a cylindrical stellite sheet is fixed onto the sliding portion of the valve rod and welded together by friction-stir welding, and after that, the cutting process is applied to the surface.

What is claimed is:

1. A steam turbine valve, comprising:
a valve seat, a valve body, and a valve rod fixed to the valve body,
wherein the valve seat, the valve rod, or the valve body is constructed by ferrite cast steel as base material of the valve seat or the valve rod and a 3 to 5 mm thick stellite sheet welded to the ferrite cast steel by friction-stir welding.

2. The steam turbine valve according to claim 1,
wherein a stellite layer made of the stellite sheet welded by friction-stir welding is equiaxial crystal and cast structure is not included.

3. The steam turbine valve according to claim 1,
wherein a stellite layer is made of the stellite sheet welded by friction-stir welding, and an inclusion of iron into the stellite layer up to 2 mm thick in the direction of ferrite cast steel from the surface of the stellite layer is 3% or less by weight.

4. The steam turbine valve according to claim 1,
wherein a dilution layer is formed between a stellite layer made of the stellite sheet welded by friction-stir welding and the ferrite cast steel, and the thickness of dilution layer is 1 to 2 mm.

5. The steam turbine valve according to claim 1,
wherein the stellite layer made of the stellite sheet welded by friction-stir welding is provided on a circular contact portion of the valve seat to come in contact with the valve body.
